(19) United States
(12) Patent Application Publication
(10) Pub. No.: US 2025/0232587 A1
(43) Pub. Date: Jul. 17, 2025

(54) METHOD FOR THERMAL VIDEO SURVEILLANCE BASED ON FEATURE POOLING MODULE

(71) Applicant: Ashish GHOSH, Kolkata (IN)

(72) Inventors: Manoj Kumar PANDA, Gunupur (IN); Badri Narayan SUBUDHI, Nagrota (IN); T. Veerakumar, Ponda (IN); Vinit JAKHETIYA, Nagrota (IN); S. Esakkirajan, Coimbatore (IN); Ashish GHOSH, Kolkata (IN)

(21) Appl. No.: 18/411,060

(22) Filed: Jan. 12, 2024

(51) Int. Cl. G06V 20/52; G06T 7/194; G06V 10/44

(52) U.S. Cl. CPC G06V 20/52; G06T 7/194; G06V 10/44

(57) ABSTRACT

The present invention relates to a method for thermal video surveillance based on an Encoder-Decoder-induced feature pooling module. The method is explained as follows: An input thermal image that is to be processed, by a pre-trained ResNet-152 deep learning network, wherein the network comprises several convolutional layers, batch normalization layers, and a rectified linear unit (ReLU) function to extract features at low, mid and high levels, and the in-depth target features; receiving, by a feature pooling module (FPM), from the deep learning network, wherein the feature pooling module comprises of a max pooling layer, a convolutional layers, and various atrous convolutional layers for extracting the target features in higher dimensional features space at multi-scales; obtaining higher dimensional features space by a decoder network, wherein the decoder network is configured to project the higher dimensional features into image space for the generation of a probability mask.

### FIELD OF INVENTION

The present invention generally relates to the field of image processing. The present invention particularly relates to a method for thermal video surveillance utilizing image feature extraction by using a feature pooling module.

### BACKGROUND OF THE INVENTION

Nowadays imaging is widely used in many different applications such as surveillance, monitoring, and security. In the last two decades, feature-based target detection and classification technology has become a hotspot for computer vision research and is widely applied in the military and civil fields. In the past few decades, research and development in automatic vision-based surveillance systems have been gaining popularity because of their massive real-time applications. It is a process of detecting moving objects followed by tracking the same from a video scene. For the surveillance system, the visual sensor is an essential component. The visual sensor can capture the image in grayscale or RGB plane with detailed textural information and better spatial resolution. However, these kinds of images are immensely afflicted by variations in illumination. Furthermore, the visual sensor is unable to provide better accuracy during night time due to low visibility. Hence, to make the surveillance system automated and facilitate continuous monitoring of the objects on a 24-hour basis, a thermal sensor is preferred these days.

However, it is more difficult under circumstances such as dynamic background, noise level uncertainty, low contrast, poor resolution, and the nearby pixels' multi-level brightness for the deep neural network to detect the moving objects from thermal videos, which requires detection at a multi-scale level. For example, while the network may be able to detect a single object, it may be more difficult for the network to detect multiple objects at small and large scales.

There are several patent applications that provide image segmentation. One such Patent Application is CN109767438B2 discloses an infrared thermal image defect feature identification method based on dynamic multi-target optimization, which comprises the steps of selecting transient thermal response of pixel points by changing the step length of a thermal image sequence, classifying by adopting FCM (fuzzy C-means) to obtain the category of the transient thermal response of each pixel point, constructing a corresponding multi-target function by considering the similarity of the pixel value of each category of pixel points and the similar pixel points and the difference of different categories of pixel points, providing a guide direction for population evolution by a prediction mechanism after each environment is changed, helping a multi-target optimization algorithm to quickly respond to new changes to obtain a dimension reduction result of the thermal image sequence, and finally extracting the defect features of the infrared thermal image by using a pulse coupling neural network, thereby realizing the accurate selection of representing the transient thermal response (temperature points) and ensuring the accuracy of defect feature extraction, meanwhile, the calculation consumption of obtaining each category of information representing transient heat under a dynamic environment is reduced.

CN107833186A discloses a simple lens spatial variations image recovery method based on Encoder-Decoder deep learning models. Picture rich in detail corresponding to the simple lens and blurred picture pair are obtained first, build the data set of simple lens spatial variations, the Encoder-Decoder deep learning models for end-to-end image restoration are built again, Encoder-Decoder deep learning models are trained using constructed data set, obtain the Encoder-Decoder deep learning models corresponding to each image block of spatial variations that training is completed, for the blurred picture of the new shooting of simple lens, by blurred picture piecemeal, then each blurred picture block is directly inputted into the corresponding Encoder-Decoder deep learning models trained, the restoration result of each Encoder-Decoder deep learning models is finally spliced into final restored image. PSF of the present invention without individually estimating simple lens, can avoid substantial amounts of Optimized Iterative processes in the existing method, and image processing speed faster, can be corrected to the aberration and aberration of simple lens, be easy to apply in practice simultaneously.

In view of the above problems associated with the state-of-the-art techniques, there is a need for a system or method that is capable of handling challenging thermal video scenes such as dynamic background, low resolution (or) missing information, low signal-to-noise ratio, lack of structure such as shape and textural information and provides better accuracy as compared to existing deep learning architectures.

### Objectives of the Invention

The primary objective of the present invention is to provide a method capable of handling challenging thermal video scenes and providing better accuracy to perform monitoring in adverse environmental conditions, and Night vision surveillance.

Another objective of the present invention is to provide better efficiency in the presence of multiple moving objects at small and large scales in complex thermal video scenes.

The advantages of the present invention will become apparent from the following description taken in connection with the accompanying drawings, wherein, by way of illustration and example, the aspects of the present invention are disclosed.

### SUMMARY OF THE INVENTION

The present invention relates to a method for thermal video surveillance based on an Encoder-Decoder-induced feature pooling module. The method is explained as follows: An input thermal image that is to be processed, provided to a pre-trained ResNet-152 deep learning network from an internal storage means or via external storage means, the network comprises several convolutional layers, batch normalization layers, and a rectified linear unit (ReLU) function to extract features at different levels, and the in-depth target features; receiving, by a feature pooling module (FPM), from the deep learning network, wherein the feature pooling module comprises of a max pooling layer, a convolutional layers, and multiple atrous convolutional layers for extracting the in higher dimensional features space at multi-scales; obtaining higher dimensional features space by a decoder network, wherein the decoder network is configured to project the higher dimensional features into image space for the generation of a probability mask.

### BRIEF DESCRIPTION OF DRAWINGS

The present invention will be better understood after reading the following detailed description of the presently preferred aspects thereof with reference to the appended drawings, in which the features, other aspects, and advantages of certain exemplary embodiments of the invention will be more apparent from the accompanying drawing in which:

FIG. 1 illustrates a block diagram of a thermal video system in accordance with an embodiment of the present invention.

FIG. 2 illustrates a schematic diagram of a feature pooling module (FPM).

FIG. 3 illustrates the visual demonstration of the detected results obtained by the proposed system is carried out using various thermal sequences.

FIG. 4 illustrates a flowchart of the proposed thermal video surveillance system.

### DETAILED DESCRIPTION OF THE INVENTION

The following description describes various features and functions of the disclosed system with reference to the accompanying figures. In the figures, similar symbols identify similar components, unless context dictates otherwise. The illustrative aspects described herein are not meant to be limiting. It may be readily understood that certain aspects of the disclosed system can be arranged and combined in a wide variety of different configurations, all of which have not been contemplated herein.

Accordingly, those of ordinary skill in the art will recognize that various changes and modifications of the embodiments described herein can be made without departing from the scope of the invention. In addition, descriptions of well-known functions and constructions are omitted for clarity and conciseness.

Features that are described and/or illustrated with respect to one embodiment may be used in the same way or in a similar way in one or more other embodiments and/or in combination with or instead of the features of the other embodiments.

The terms and words used in the following description are not limited to the bibliographical meanings, but, are merely used to enable a clear and consistent understanding of the invention. Accordingly, it should be apparent to those skilled in the art that the following description of exemplary embodiments of the present invention are provided for illustrative purposes only and not for the purpose of limiting the invention.

It is to be understood that the singular forms “a”, “an” and “the” include plural referents unless the context clearly dictates otherwise.

It should be emphasized that the term “comprises/comprising” when used in this specification is taken to specify the presence of stated features, integers, steps, or components but does not preclude the presence or addition of one or more other features, steps, components, or groups thereof. The equations used in the specification are only for computation purposes.

The present invention relates to a method for thermal video surveillance based on a feature pooling module. The present invention provides an effective end-to-end encoder-decoder deep learning framework for thermal video surveillance. In the present invention, a modified ResNet-152 network acts as an encoder and extracts the features at multi-scale levels. Also, the transfer learning mechanism in the encoder network boosts the performance of the proposed system. Further, a feature-pooling module is used among the encoder and decoder networks that project the higher dimensional feature space into sparse and dense feature space. The decoder network is configured to perform up-sampling to learn a mapping from the feature space to the image space effectively.

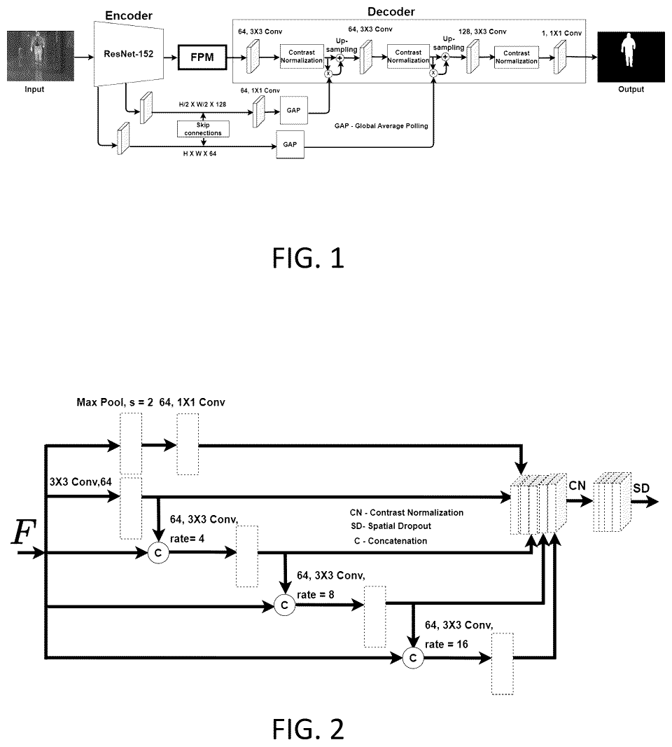

A block diagram of a thermal video system is illustrated in FIG. 1. The system comprises a pre-trained deep learning network or a modified ResNet-152 network as an encoder, a feature pooling module (FPM), and a decoder network.

Experimental data: In one case, the proposed system is implemented on NVIDIA Jetson Xavier NX Developer Kit that includes a power-efficient, compact Jetson Xavier NX module for AI edge devices.

According to an embodiment, a thermal image is processed as input to the proposed end-to-end deep learning framework via internal or external storage means of a computing device. In an exemplary embodiment, the deep learning network is configured in a computing device. The computing device is selected from but not limited to a computer, a laptop, and a tablet. The storage means are selected from but not limited to, random access memory (RAM), read-only memory (ROM), Hard Disk and solid-state drive SSD, pen driver, and SD card. In one case the framework is stored in the storage means of the computing device. The computing device may include a processing unit and the processing unit is configured to run/execute the end-to-end deep learning framework responsive to the user input.

In an embodiment, a pre-trained ResNet-152 network adhered as an encoder that incorporates initial three blocks where each block consists of convolution layers, batch normalization layers, and one or more rectified linear unit functions (ReLU). The ResNet-152 is a pre-trained deep neural network that is capable of retaining low, mid, and high-level features.

The pre-trained deep learning network is configured to acquire image feature data of the thermal image. The pre-trained deep learning network (i.e. ResNet-152) comprises a plurality of convolution layers, batch normalization layers, and a rectified linear unit (ReLU) function that is configured to extract a plurality of in-depth features at low, mid, and high levels. Convolutional layers are used in deep neural networks to automatically and adaptively learn patterns and features from input data, making the convolutional layers especially well-suited for tasks like image recognition, object detection, and image segmentation. In a convolutional layer, a filter (also known as a kernel) is applied to the input data. The filter is typically a small, learnable matrix with trainable weights. The results of the convolutional layers are called a feature map which highlights certain patterns or features present in the input. Batch normalization layers help to accelerate the training of deep neural networks by reducing internal covariate shifts. It allows for the use of higher learning rates, which can speed up convergence. Also, batch normalization acts as a form of regularization, reducing the need for dropout or other regularization techniques. Thus, the batch normalization layers can help prevent overfitting. Further, networks with batch normalization tend to generalize better to unseen data, resulting in improved test performance.

The ReLU function introduces non-linearity to the network. The nonlinearity is essential for enabling deep networks to learn complex, non-linear relationships in data. Also, the ReLU function encourages sparsity in neural activations. This means that a substantial portion of the neurons remain inactive (outputting zero) for most inputs. The sparsity can lead to more efficient representations and faster training since fewer parameters need to be updated. Furthermore, compared to activation functions like sigmoid and tanh, which saturate (flatten) for extreme input values, ReLU has a gradient of 1 for positive inputs. This property helps mitigate the vanishing gradient problem, making it easier to train deep networks. When gradients are not too small, the network can learn faster and more effectively.

The pre-trained deep learning network includes an initial three blocks named block-1, block-2, and block-3. In the modified ResNet-152 network, block-1 initially captures features from an input dimension of H×W×1 and transforms the features into a feature set of H×W×64. Here H (i.e. Height)×W (i.e. width) denotes the dimension of the input thermal image, “1” denotes the single image, and “64” indicates the learned representations at a particular block in a deep neural network. The features extracted by block-1 are then passed on to the block-2, where the extracted features undergo a feature space transformation, projecting the extracted features from H×W×64 to H/2×W/2×256. Subsequently, the output from block-2 is forwarded to block-3, which conducts another feature space projection, altering the feature space from H/2×W/2×256 to a dimension of H/4×W/4×512. It is to be noted that the first two block weights are the same as the pre-trained ResNet-152 network, and the weights for the third block are learned by using transfer learning. In the ResNet-152 network, a max-pooling layer is removed between the first two blocks (block-1, block-2) to increase the use of deep multi-layer features with high spatial resolution.

The process of obtaining features from the target thermal image using an encoder is explained as follows: For example, a thermal image as input with size H×W×1. Here H (i.e. Height)×W (i.e. width) denotes the dimension of the input thermal image given to the encoder network to extract features at low, mid, and high levels. It is to be noted that, the feature-pooling module is used among the encoder and decoder network and the module projects the higher dimensional feature space into sparse and dense feature space. The sparse and dense feature spaces represent the feature at a higher dimensional space which can better separate the foreground and background with a simple decision boundary. Further, the decoder network comprises stacked convolutional layers and an up-sampling operator that projects the feature space into image space accurately.

The following illustrates the experimental data of the present invention and should not be construed to limit the scope of the present invention.

Experimental data: The system of the present invention is evaluated on a CDNet-2014 benchmark dataset. The performance of the proposed system is verified by comparing the results obtained by it the nineteen state-of-the-art change detection techniques.

Table 1 shows the quantitative comparison of thermal sequences with non-deep learning and deep learning-based methods in comparison with the method of the present invention on the CDNet-2014 dataset.

| | | Avg. | Avg. | Avg. | Avg. |
|---|---|---|---|---|---|
| | Approaches | Precision | Recall | F-measure | PWC |
| Non-deep | Fuzzy Mode | 0.9344 | 0.9766 | 0.9550 | 1.1130 |
| learning | KDE | 0.8974 | 0.6725 | 0.7423 | 1.6795 |
| | GMM | 0.8652 | 0.5691 | 0.6621 | 4.2642 |
| | PAWCS | 0.8280 | 0.8504 | 0.8324 | 1.4018 |
| | SuBSENSE | 0.8328 | 0.8161 | 0.8171 | 2.0125 |
| | SOBS-CF | 0.8715 | 0.6347 | 0.7140 | 1.8021 |
| | WeSamBE | 0.8554 | 0.7727 | 0.7962 | 2.3538 |
| | Multimode Background | 0.8268 | 0.8162 | 0.8194 | 1.4289 |
| | Shared Model | 0.8072 | 0.8618 | 0.8319 | 1.8656 |
| | Spectral-360 | 0.9114 | 0.7238 | 0.7764 | 1.6337 |
| Deep | DeepBS | 0.9257 | 0.6637 | 0.7583 | 3.5773 |
| learning | WisenetMD | 0.8696 | 0.7867 | 0.8152 | 1.8993 |
| | Cascade CNN | 0.8577 | 0.9461 | 0.8958 | 1.0478 |
| | IUTIS-5 | 0.8969 | 0.7990 | 0.8303 | 1.1484 |
| | BSUV-Net | 0.8551 | 0.8739 | 0.8581 | 1.7058 |
| | SemanticBGS | 0.9118 | 0.7664 | 0.8219 | 1.3897 |
| | BSUV-Net 2.0 | 0.9359 | 0.8594 | 0.8932 | 1.1659 |
| | BSPVGAN | 0.9770 | 0.9763 | 0.9764 | 0.2406 |
| | MU-NET1 | 0.9799 | 0.9852 | 0.9825 | 0.1389 |
| | Proposed system of | 0.9942 | 0.9877 | 0.9909 | 0.0895 |
| | present invention | | | | |

Initially, the block-1 of the modified ResNet-152 network extracts features from H×W×1 to H×W×64. Here H (i.e. Height)×W (i.e. width) denotes the dimension of the input thermal image, “1” denotes the single image, and “64” indicates the learned representations at a particular block in a deep neural network. Further, the features extracted by block 1 are provided to block 2 which projects the feature space from H×W×64 to H/2×W/2×256.

Henceforth, the output of block-2 is given to block-3 which projects feature space from H/2×W/2×256 to H/4×W/4×512. It is to be noted that in order to use the low-level feature in the method of the present invention, a 3×3 convolution layer with 64 filters is applied at the beginning of the first block and a 3×3 convolution layer with 128 filters at the end of the first block of the modified ResNet-152 encoder network. The low-level features are propagated towards the decoder network through shortcut connections followed by global average pooling (GAP) and fused with higher-level features that improve the feature representation (as shown in FIG. 1 and FIG. 4).

Referring to FIG. 2, the feature pooling module (FPM) is configured between the encoder-decoder network to preserve the sparse and dense features from in-depth target multi-layer features obtained as output of the encoder network.

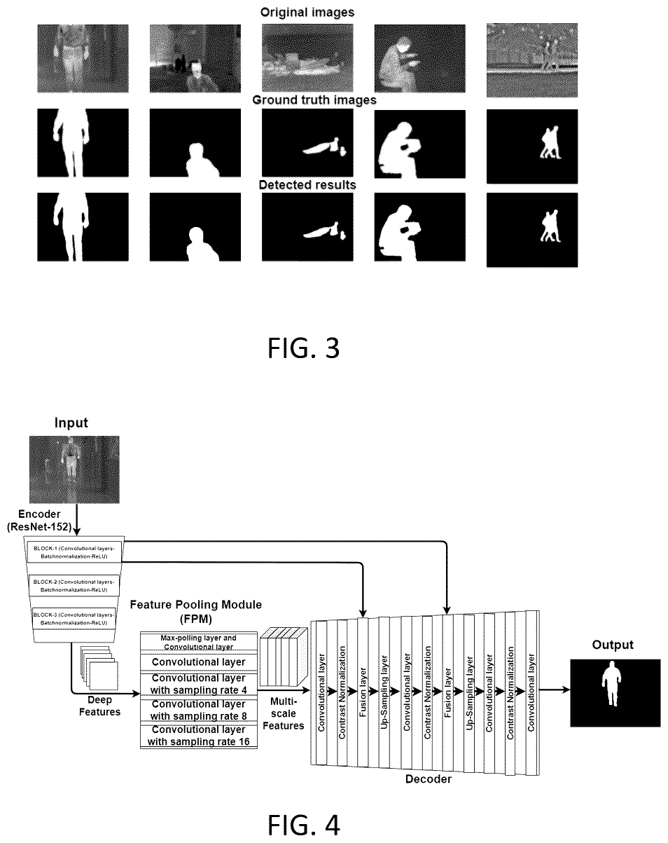

The visual analysis of the change detection results obtained by the proposed system is carried out using various thermal sequences (as shown in FIG. 3). All the original images and the corresponding ground-truth images of the thermal sequences are shown in the first and second rows of FIG. 3. The results obtained by the proposed method are presented in the third row of FIG. 3 where it is found that the proposed method accurately classified the foreground and background pixels in the target image. Also, the proposed method precisely detects the shape of the moving objects with lesser noise for thermal image sequences.

Referring to FIG. 2 and FIG. 4, the FPM module comprises a max pooling layer, a convolutional layer, and plurality ordered of atrous convolutional layers with different sampling rates for projecting the in-depth features into higher dimensional features space at multi-scales. The FPM module has a max pooling module, a convolution layer, and multiple atrous convolutional layers that accurately capture the multi-scale moving objects from the challenging thermal video scenes.

The deep feature maps (F) of size H/4×W/4×512 extracted from the encoder network are given to an FPM module. The FPM module consists of the max pooling layer and a plurality order of convolutional layers with different sampling rates (such as 4, 8, and 16). The max-pooling layer is utilized to preserve useful information from the encoder output (F). The max pooling layer is configured to preserve the maximum value in every pooling area, which can ensure that the result of pooling layers has no changes if other values in the pooling block have small changes. Again, the feature maps (F) from the encoder are given to a 3×3 convolutional layer with 64 filters which preserve the sparse information of the deep features. The convolutional layer is utilized to attain the spatial details of the thermal image using convolutional kernels. Further, three 3×3 convolutional layers with different sampling rates retain the dense features from the encoder output. The convolutional layers with different sampling rates or atrous convolutional layers can retain the dense features from the in-depth features of the encoder by increasing the receptive field. Feature maps from the max-pooling layer, a convolutional layer, and three atrous convolutional layers are concatenated along the channels to project the in-depth features into sparse and dense features. The FPM module produces the multi-scale features of size H/4×W/4×320 by processing these feature maps through contrast normalization and spatial dropout as shown in FIG. 2. The use of contrast normalization instead of batch normalization enhances the performance of the FPM module. Also, the use of a spatial dropout layer with a rate of 0.25 increases the learning performance of the proposed model with fewer training samples.

Referring to FIG. 4, the decoder module or network contains three blocks where the initial two blocks comprise the stack of convolution layer, contrast normalization layer, ReLU activation function, fusion layer, and up-sampling operator. The first block of the decoder network projects the feature space from H/4×W/4×320 to H/4×W/4×64 followed by contrast normalization layer and ReLU activation function. The contrast normalization layer aims to improve the network's ability to learn meaningful representations by normalizing the contrast, or differences in feature activations, across different parts of the input data. The convolutional operation is linear which limits the performance of a deep neural network. A convolutional layer with a ReLU activation function introduces nonlinearity in the network, which helps to learn the challenging scenes. The fusion layer in the decoder network enhances the feature representation where the low-level features are initially multiplied with the output of the decoder's first block and subsequently combined with the initial feature maps obtained by the same. Here for fusion, the low-level features are extracted using a 3×3 convolutional layer with 128 filters from the end of the encoder's first block and propagated towards the decoder network followed by skip connection and global average pooling (GAP) layer. Finally, these fused feature maps are up-sampled with dimensions of H/2×W/2×64 and given to the next block. Here, a similar kind of operation is performed, and the fusion layer boosts the feature representation. Here, for fusion, the low-level features are extracted using a 3×3 convolutional layer with 64 filters from the beginning of the encoder's first block and propagated towards the decoder followed by skip connection and global average pooling (GAP) layer. The fused feature maps from the fusion layer are up-sampled with dimensions H×W×64 and fed to the third block of a decoder network, which projects the fused features into H×W×128 feature maps. The third block of the decoder network comprises the convolution layer, and contrast normalization layer followed by the ReLU activation function. The outcomes of the third block are given to the convolution layer with a sigmoid activation function which projects H×W×128 feature maps into H×W×1 feature map.

The decoder module is configured to project the higher dimensional multi-scale features into image space for the generation of a probability mask. The decoder network fully uses low-level and multi-scale features to generate a foreground segmented probability mask for the corresponding image of size H×W×1. A probability mask in moving object detection refers to a map that assigns a probability value to each pixel in an image, indicating the likelihood that the pixel belongs to a foreground or background. This probability map is typically used in computer vision and image analysis applications to identify objects that are in motion within an image. The higher dimensional features can capture complex and multi-faceted information about the images, allowing for more advanced analysis and understanding. It is to be noted that the end convolutional layer with a sigmoid activation function in the decoder network projects the feature space into image space where foreground and background pixels are separated accurately.

While this invention has been described in connection with what is presently considered to be the most practical and preferred embodiment, it is to be understood that the invention is not limited to the disclosed embodiments, but, on the contrary, is intended to cover various modifications and equivalent arrangements included within the scope of the appended claims.

We claim:

1. A method for thermal video surveillance based on a feature pooling module, comprising of:
a) a pre-trained deep learning network comprises a block1, a block2, and a block3, wherein each of said block comprises of a plurality of convolution layers, batch normalization layers, and ReLU functions that are configured to extract in-depth features from an input target image;
wherein,
i. receiving, by a feature pooling module (FPM), the extracted in-depth features from the deep learning network, wherein the feature pooling module comprises a max pooling layer, a convolutional layer, and a plurality of ordered atrous convolutional layers, wherein the FPM module is configured to project the in-depth target features into higher dimensional features space; and
ii. obtaining the higher dimensional feature space by a decoder network from the FPM, wherein the decoder network is configured to project the higher dimensional features into image space for the generation of a probability mask.

2. The method claimed in claim 1, wherein the pre-trained deep learning network is a modified ResNet-152 network acting as the encoder.

3. The method as claimed in claim 1, wherein the FPM module comprises a max pooling layer, a 3×3 convolution layer with 64 filters, and 3×3 convolution layers, 64 filters with sampling rates of 4, 8, and 16.

4. The method as claimed in claim 1, wherein the max pooling layer is configured to preserves the maximum value in every pooling area, which can ensure that the result of pooling layers has no changes.

5. The method as claimed in claim 1, wherein the decoder network comprises three blocks where the initial two blocks (block1 and block2) comprise the stack of convolution layer, contrast normalization layer, ReLU activation function, fusion layer, and up-sampling operator.

6. The method as claimed in claim 5, wherein the third block (block3) of the decoder network comprises a convolution layer and a contrast normalization layer followed by the ReLU activation function.

7. The method as claimed in claim 1, wherein the higher dimensional features can capture complex and multi-faceted information about the images, allowing for more advanced analysis and understanding.

8. The method as claimed in claim 1, wherein the end convolutional layer with a sigmoid activation function in the decoder network project the feature space into image space where foreground and background pixels are separated accurately.
